(19) United States
(12) Patent Application Publication
(10) Pub. No.: US 2019/0378345 A1
(43) Pub. Date: Dec. 12, 2019

(54) LOCATING AND BIDDING FOR A PARKING SPACE VIA PEER-TO-PEER COMMUNICATION OF PARKING INFORMATION

(71) Applicant: Capital One Services, LLC, McLean, VA (US)

(72) Inventors: Michael Mossoba, Arlington, VA (US); Joshua Edwards, Philadelphia, PA (US); Abdelkadar M'Hamed Benkreira, Washington, DC (US)

(21) Appl. No.: 16/002,933

(22) Filed: Jun. 7, 2018

(51) Int. Cl. G07B 15/02; G06Q 20/40; G06Q 30/08; G01C 21/36

(52) U.S. Cl. CPC G07B 15/02; G01C 21/3685; G06Q 30/08; G06Q 20/40

(57) ABSTRACT

A device receives, from a first device associated with a first vehicle, parking space size information for a parking space occupied by the first vehicle, and parking space location information. The device receives, from a second device associated with a second vehicle, information indicating that the second vehicle is looking for a parking space in a geographical area for a price, and determines that the parking space is in the geographical area. The device determines that the second vehicle fits in the parking space, and receives, from the second device, information indicating that the second vehicle is located at the parking space. The device provides, to the first device, the information indicating that the second vehicle is located at the parking space, and causes a transaction that transfers money, based on the price, from an account associated with the second device to an account associated with the first device.

### BACKGROUND

Parking is the act of stopping and disengaging a vehicle and leaving it unoccupied. In some instances, parking a vehicle requires payment of a fee (e.g., to a parking meter) that depends upon a time period the vehicle is parked. Vehicle operators may pay for parking with coins, credit cards, and/or mobile applications tied to a transaction card and/or a transaction account.

### SUMMARY

According to some implementations, a device may include one or more memories, and one or more processors configured to receive, from a first device associated with a first vehicle, parking space size information indicating a size of a particular parking space occupied by the first vehicle, and receive, from the first device, parking space location information indicating a location of the particular parking space. The one or more processors may receive, from a second device associated with a second vehicle, information indicating that the second vehicle is looking for a parking space in a geographical area for a particular price, and may determine, based on the parking space location information, that the particular parking space is in the geographical area. The one or more processors may determine, based on the parking space size information, that the second vehicle physically fits in the particular parking space, and may provide, to the first device, a first notification indicating that the second vehicle accepts the particular price for the particular parking space, based on determining that the particular parking space is in the geographical area and that the second vehicle physically fits in the particular parking space. The one or more processors may receive, from the first device and based on the first notification, a response indicating agreement to make the particular parking space available to the second vehicle, and may provide, to the second device and based on the response, information indicating the agreement to make the particular parking space available to the second vehicle. The one or more processors may receive, from the second device, information indicating that the second vehicle is located at the particular parking space, based on providing the information indicating the agreement to make the particular parking space available to the second vehicle, and may provide, to the first device, the information indicating that the second vehicle is located at the particular parking space to prompt the first vehicle to exit the particular parking space and the second vehicle to enter the particular parking space. The one or more processors may cause a transaction that transfers an amount of money, based on the particular price, from an account associated with the second device to an account associated with the first device, after the first vehicle exits the particular parking space and the second vehicle enters the particular parking space.

According to some implementations, a non-transitory computer-readable medium may store instructions that include one or more instructions that, when executed by one or more processors of a device, cause the one or more processors to receive, from a first device associated with a first vehicle, parking space size information indicating a size of a particular parking space occupied by the first vehicle, and receive, from the first device, parking space location information indicating a location of the particular parking space. The one or more instructions may cause the one or more processors to receive, from a second device associated with a second vehicle, information indicating that the second vehicle is looking for a parking space in a geographical area for a particular price, and determine, based on the parking space location information, that the particular parking space is in the geographical area. The one or more instructions may cause the one or more processors to determine, based on the parking space size information, that the second vehicle physically fits in the particular parking space, and provide, to the first device, a first notification indicating that the second vehicle will pay the particular price for the particular parking space, based on determining that the particular parking space is in the geographical area and that the second vehicle physically fits in the particular parking space. The one or more instructions may cause the one or more processors to receive, from the first device and based on the first notification, a response indicating that the first vehicle will give the particular parking space to the second vehicle, and calculate, based on the response, driving directions from a current location of the second vehicle to the location of the particular parking space. The one or more instructions may cause the one or more processors to provide, to the second device, the driving directions from the current location of the second vehicle to the location of the particular parking space, and determine, based on a location of the second vehicle, when the second vehicle is located at the particular parking space. The one or more instructions may cause the one or more processors to provide, to the first device, information indicating that the second vehicle is located at the particular parking space to prompt the first vehicle to exit the particular parking space and the second vehicle to enter the particular parking space, and cause a transaction that transfers compensation, based on the particular price, from an account associated with the second device to an account associated with the first device, after the first vehicle exits the particular parking space and the second vehicle enters the particular parking space.

According to some implementations, a method may include receiving, by a device and from a first user device associated with a first vehicle, parking space size information indicating a size of a particular parking space occupied by the first vehicle, and receiving, by the device and from the first user device, parking space location information indicating a location of the particular parking space. The method may include receiving, by the device and from a second user device associated with a second vehicle, information indicating that the second vehicle is seeking a parking space in a geographical area for a particular price, and determining, by the device and based on the parking space location information, that the particular parking space is in the geographical area. The method may include determining, by the device and based on the parking space size information, that the second vehicle physically fits in the particular parking space, and providing, by the device and to the first user device, a first notification indicating that the second vehicle will pay the particular price for the particular parking space, based on determining that the particular parking space is in the geographical area and that the second vehicle physically fits in the particular parking space. The method may include receiving, by the device, from the first user device, and based on the first notification, a response indicating that the first vehicle will give the particular parking space to the second vehicle, and providing, by the device, to the second user device, and based on the response, information indicating that the first vehicle will give the particular parking space to the second vehicle. The method may include receiving, by the device and from the second user device, information indicating that the second vehicle is located at the particular parking space, based on providing the information indicating that the first vehicle will give the particular parking space to the second vehicle, and providing, by the device and to the first user device, the information indicating that the second vehicle is located at the particular parking space to prompt the first vehicle to exit the particular parking space and the second vehicle to enter the particular parking space.

### BRIEF DESCRIPTION OF THE DRAWINGS

FIGS. 1A-1I are diagrams of an overview of an example implementation described herein.

FIG. 2 is a diagram of an example environment in which systems and/or methods, described herein, may be implemented.

FIG. 3 is a diagram of example components of one or more devices of FIG. 2.

FIG. 4 is a flow chart of an example process for locating and bidding for a parking space based on peer-to-peer communication of parking information.

### DETAILED DESCRIPTION

The following detailed description of example implementations refers to the accompanying drawings. The same reference numbers in different drawings may identify the same or similar elements.

When searching for a parking space in a geographical area, a vehicle operator may drive around the geographical area and visually search for an open parking space. Furthermore, some parking spaces are subject to restrictions (e.g., time restrictions, no parking at a particular time period, vehicle type restrictions, and/or the like). Thus, searching for and locating a parking space requires luck and patience, wastes time, wastes fuel, causes unnecessary pollution, and can be very frustrating.

Some implementations described herein provide a parking platform that locates a parking space based on peer-to-peer to communication of parking information. For example, the parking platform may receive, from a first device associated with a first vehicle, parking space size information for a parking space occupied by the first vehicle, and parking space location information. The parking platform may receive, from a second device associated with a second vehicle, information indicating that the second vehicle is looking for a parking space in a geographical area, and may determine that the parking space is in the geographical area. The parking platform may determine that the second vehicle fits in the parking space, and may receive, from the second device, information indicating that the second vehicle is located at the parking space. The parking platform may provide, to the first device, the information indicating that the second vehicle is located at the parking space, and may cause a transaction that transfers money, based on an agreed price, from an account associated with the second device to an account associated with the first device.

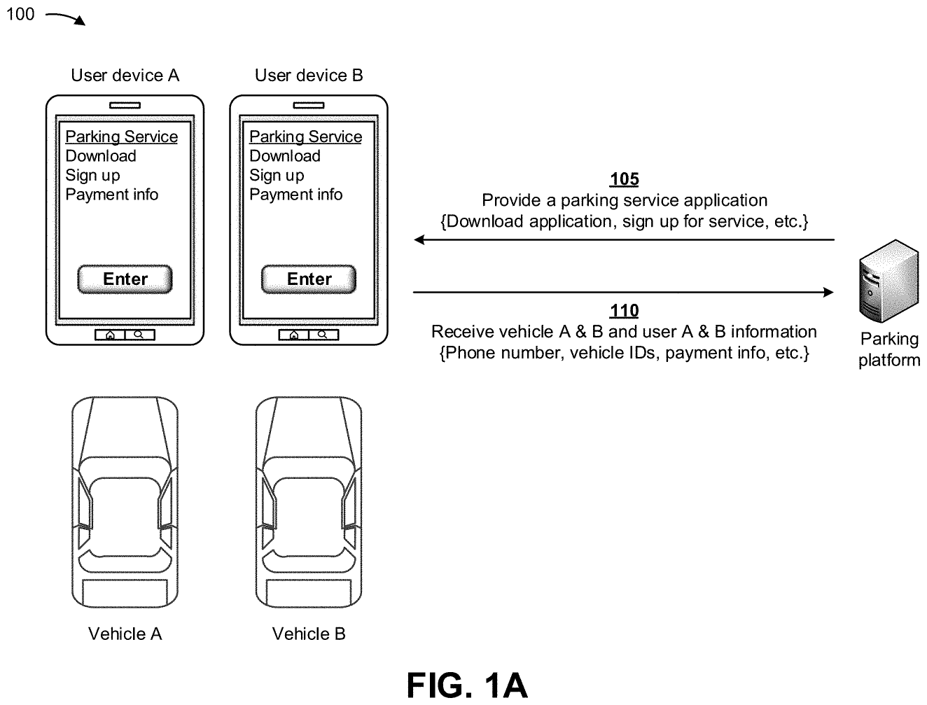

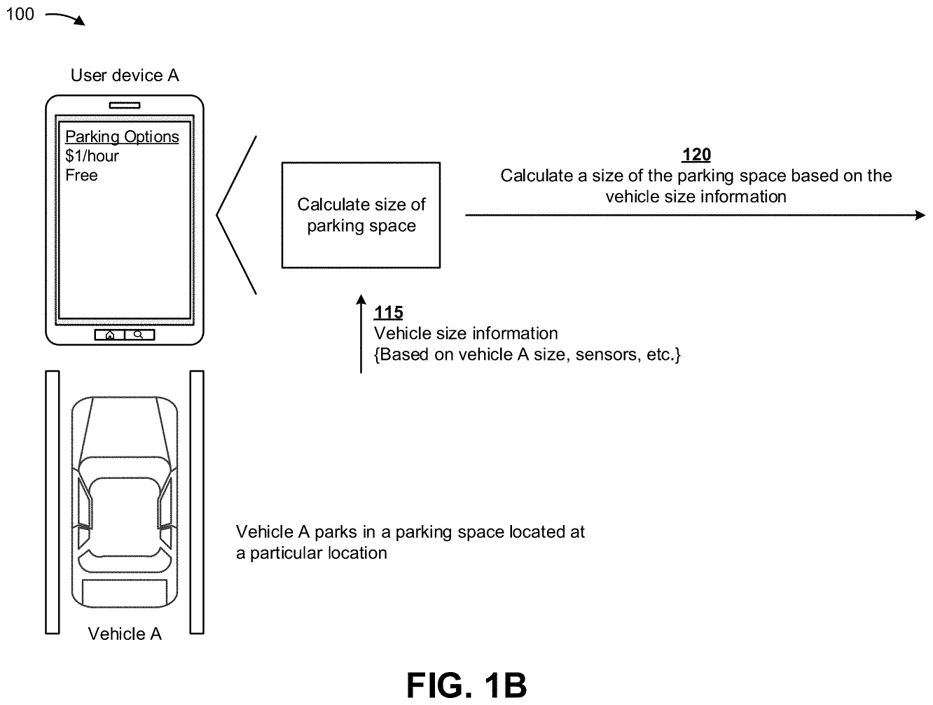

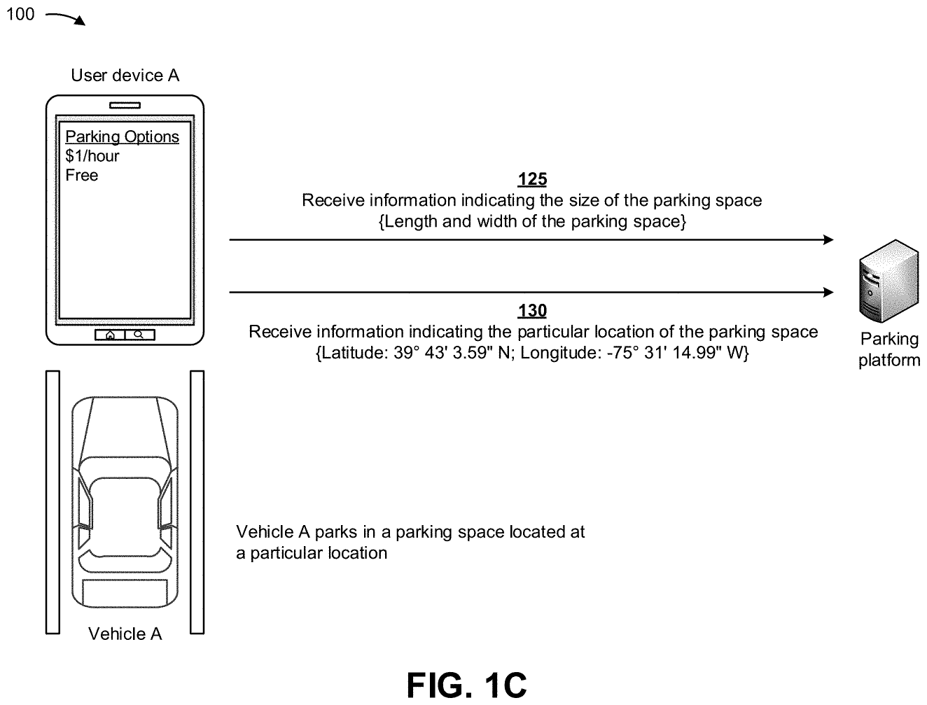

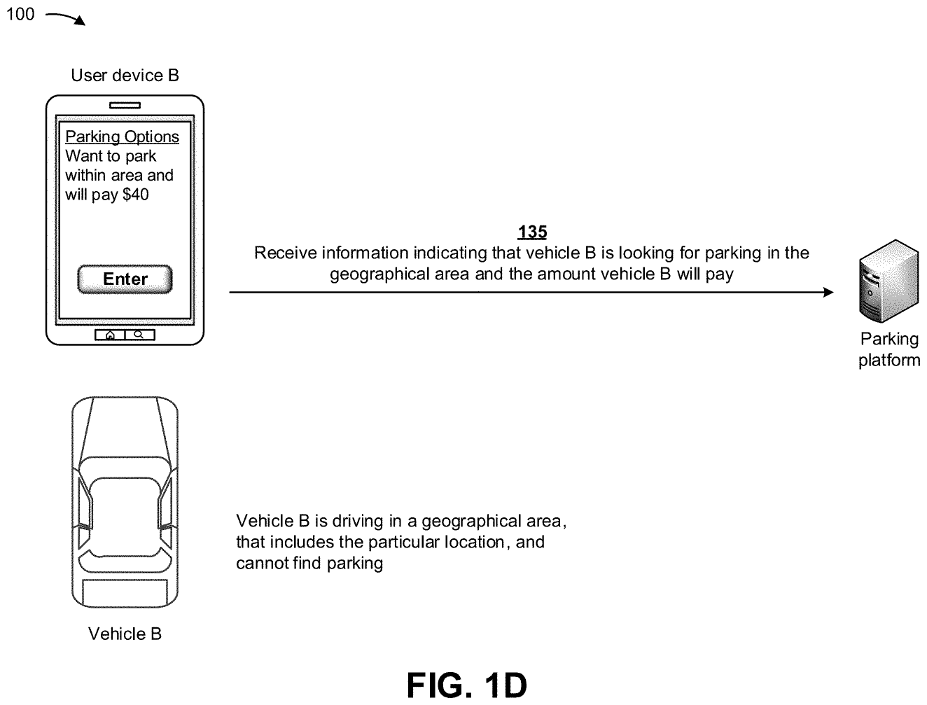

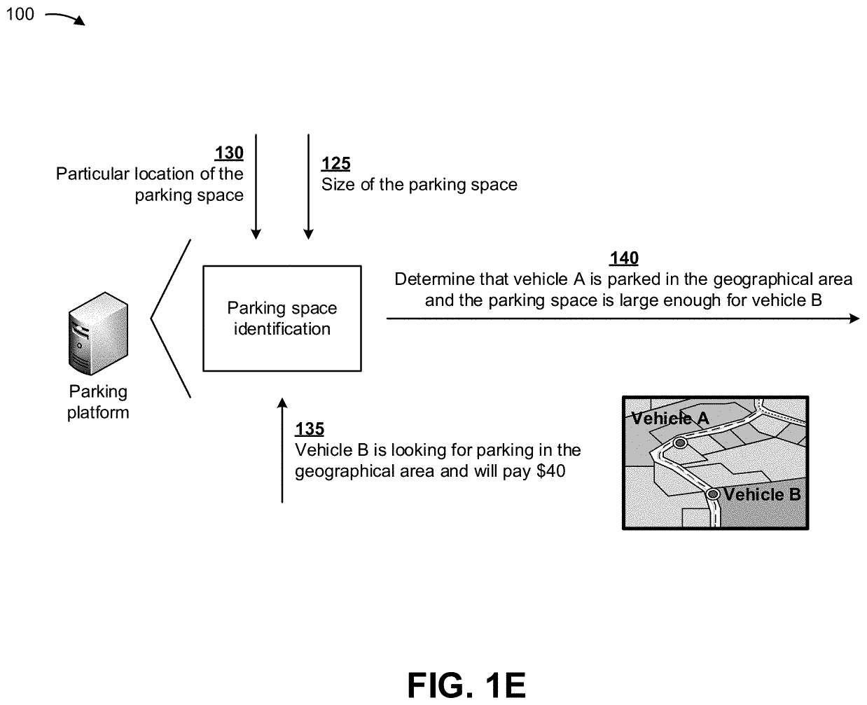

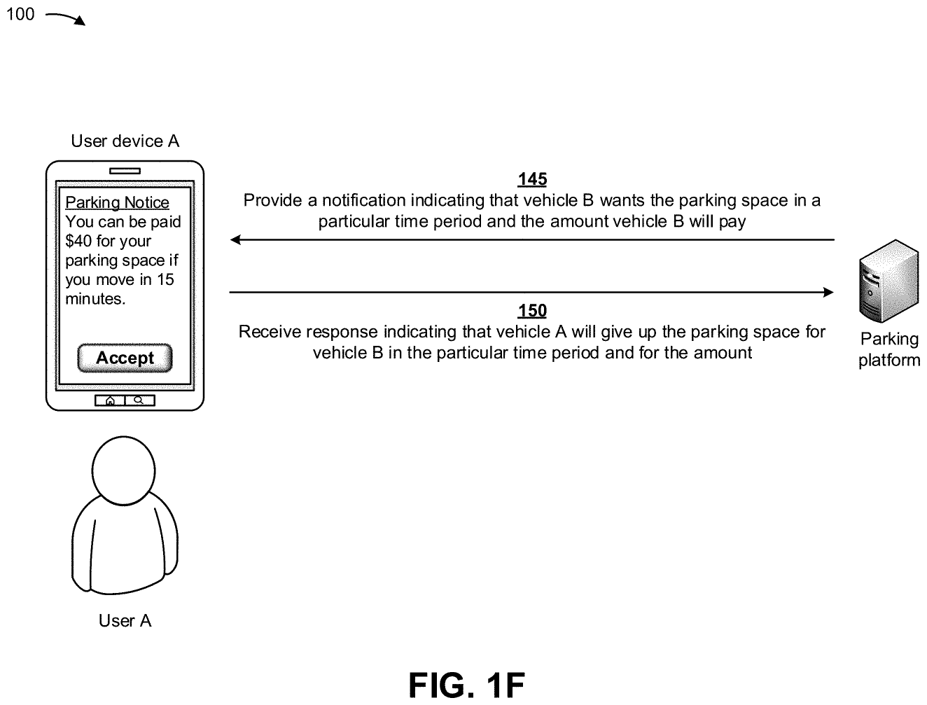

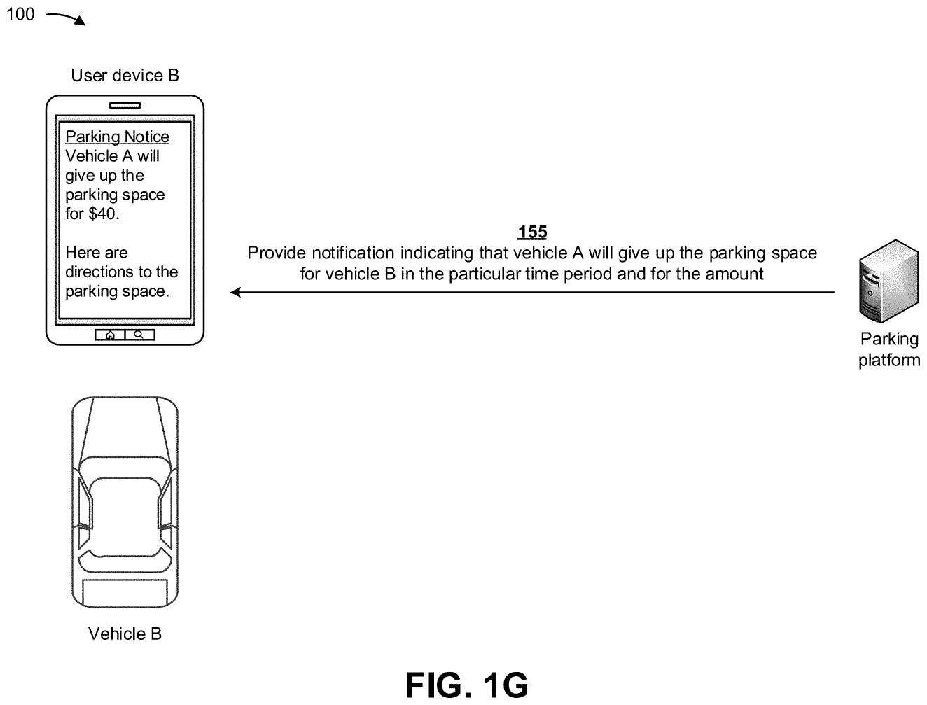

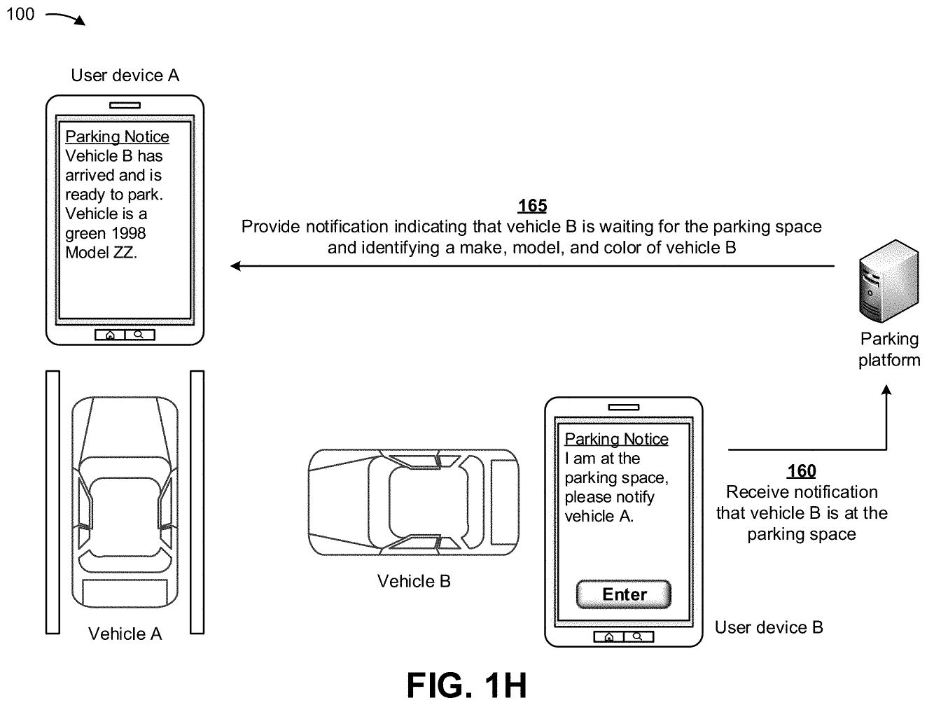

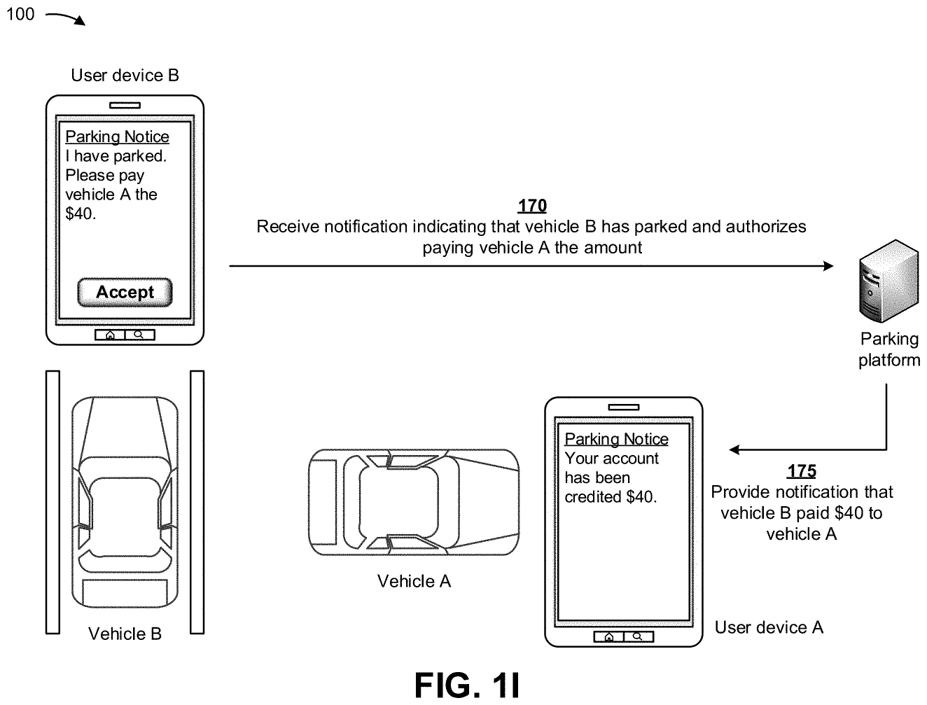

FIGS. 1A-1I are diagrams of an overview of an example implementation 100 described herein. As shown in FIG. 1A, a first user device (e.g., user device A) may be associated with a first vehicle (e.g., vehicle A), and a second user device (e.g., user device B) may be associated with a second vehicle (e.g., vehicle B). As further shown, the first user device and the second user device may be associated with a parking platform. As further shown in FIG. 1A, and by reference number 105, the parking platform may provide a parking service application to the first user device and the second user device. In some implementations, the parking service application may include an application that enables a user device (e.g., the second user device) to locate and bid for a parking space, occupied by a vehicle (e.g., the first vehicle) associated with another user device (e.g., the first user device) based on peer-to-peer communication (e.g., between user devices) of parking information, as described herein. In some implementations, the first user device and the second user device may download the parking service application from the parking platform, a first user associated with the first user device and a second user associated with the second user device may sign up for the parking service provided by the parking service application, and/or the like.

In some implementations, when signing up for the parking service, the first user may provide, via the first user device, information associated with the first vehicle (e.g., an identifier associated with a computing system of the first vehicle, an identifier associated with a global positioning system (GPS) of the first vehicle, and/or the like), information associated with the first user device (e.g., a mobile identification number (MIN), a mobile subscription identification number (MSIN), an international mobile subscriber identity (IMSI), and/or the like, of the first user device), information associated with the first user (e.g., a name, an address, a username, a password, payment information, and/or the like, associated with the first user), and/or the like. In some implementations, when signing up for the parking service, the second user may provide, via the second user device, information associated with the second vehicle, the second user device, and the second user, in a similar manner.

In some implementations, the first user and/or the second user may configure the parking service application in a variety of ways. For example, the first user and/or the second user may configure the parking service application to pay less than a particular amount for parking spaces, to identify parking spaces within a particular distance of a destination, to only identify handicap parking spaces, to only identify free parking spaces, to only identify parking spaces that can accommodate a size of the first vehicle and/or the second vehicle, to identify parking spaces on an end of a parking lot, to identify parking spaces that do not require parallel parking, and/or the like. In such implementations, the first user device and/or the second user device may provide the user configuration information to the parking platform, and the parking platform may receive and store the user configuration information.

In some implementations, a vehicle may include an autonomous vehicle, a semi-autonomous vehicle, a vehicle controlled by a user, and/or the like.

As further shown in FIG. 1A, and by reference number 110, the parking platform may receive, from the first user device, the information associated with the first vehicle, the first user device, and the first user, and may receive, from the second user device, the information associated with the second vehicle, the second user device, and the second user. In some implementations, the parking platform may register the first and second users, the first and second user devices, and the first and second vehicles for the parking service application based on the received information.

As shown in FIG. 1B, assume that a user of the first vehicle parks the first vehicle in a parking space located at a particular location, and pays for the parking space (e.g., via a parking meter, a mobile parking application, the parking service application, and/or the like). As further shown in FIG. 1B, and by reference number 115, when the first vehicle parks, the first user device may receive, from the first vehicle, vehicle size information in relation to the parking space. In some implementations, the vehicle size information may include known dimension information of the first vehicle (e.g., a length of the vehicle, a width of the vehicle, a height of the vehicle, and/or the like), relational information received from crash detection sensors or systems of the first vehicle in relation to the parking space (e.g., distances between sides of the first vehicle and the parking space lines, a distance between a front of the first vehicle and a parking space line, a distance between a rear of the first vehicle and a parking space line, and/or the like), and/or the like.

As further shown in FIG. 1B, and by reference number 120, the first user device may calculate a size of the parking space based on the vehicle size information. In some implementations, the first user device may utilize the known dimension information of the first vehicle and the relational information to calculate a size of the parking space. In some implementations, the size of the parking space may include a length, a width, and a height of the parking space. In some implementations, the first user device may determine whether the parking space has any restrictions (e.g., time restrictions, vehicle type restrictions, and/or the like) based on information received from a parking meter, images (e.g., of signage) surrounding the parking space captured by the first user device, and/or the like.

As shown in FIG. 1C, and by reference number 125, the parking platform may receive, from the first user device, information indicating the size of the parking space. For example, the parking platform may receive, from the first user device, information indicating a length and a width of the parking space. As further shown in FIG. 1C, and by reference number 130, the parking platform may receive, from the first user device, information indicating the particular location of the parking space. For example, the parking platform may receive, from a GPS component of the first user device or from the GPS of the first vehicle, information indicating the particular location of the parking space (e.g., and the first vehicle) includes a particular latitude (e.g., 39° 43′ 3.59″ N) and a particular longitude (e.g., −75° 31′ 14.99″ W).

As shown in FIG. 1D, assume that the second vehicle is driving or will be driving in a geographical area that includes the particular location of the parking space, and that the second vehicle cannot find parking or the second user knows that finding parking will be difficult. As further shown, in such a scenario, the second user may utilize a user interface of the parking service application, on the second user device, to input information indicating that the second vehicle is looking for parking in the geographical area. In some implementations, the input information may include a price the second vehicle (e.g., the second user) is willing to pay for parking. In some implementations, the price may be negotiable or dynamically determined based on a variety of factors. For example, the second user may input information indicating that the second user wants to park the second vehicle in the geographical area and that the second user is willing to pay a particular price (e.g., $40.00) to park in the geographical area. The second user may select a mechanism (e.g., an “Enter” button, icon, link, and/or the like) that, when selected, causes the second user device to provide the input information to the parking platform.

In some implementations, the second user may provide, to the second user device, information indicating different prices that the second user is willing to pay for parking in the geographical area. For example, if the particular location of the parking space is exactly where the second user wishes to park, the second user may indicate a willingness to pay a highest price for the parking space. As the locations of the parking spaces move away from the particular location, the second user may indicate a willingness to pay lesser prices for parking spaces.

As further shown in FIG. 1D, and by reference number 135, the parking platform may receive, from the second user device, the information indicating that the second vehicle is looking for parking in the geographical area and the price (e.g., $40.00) the second user is willing to pay for parking. In some implementations, the parking platform may receive, from the second user device, the information indicating different prices that the second user is willing to pay for parking in the geographical area, as described above.

As shown in FIG. 1E, and by reference numbers 125, 130, 135, and 140, the parking platform may determine, based on the size of the parking space, the particular location of the parking space, and the information indicating that the second vehicle is looking for parking in the geographical area and the price, that the first vehicle is parked in the geographical area and that the parking space is large enough for the second vehicle. In some implementations, the parking platform may identify the parking space for the second user if the parking satisfies the user configuration information associated with the first user and the second user. In some implementations, the parking platform may compare the geographical area and the particular location, and may determine that the particular location is within the geographical area. In such implementations, the parking platform may determine that the first vehicle is parked in the geographical area since the parking space is at the particular location. In some implementations, the parking platform may receive vehicle size information (e.g., a length, a width, a height, and/or the like) from a user device when the user device signs up for the parking service application. Thus, the parking platform may compare the size of the second vehicle with the size of the parking space, and may determine that the parking space is large enough for the second vehicle when the size of the parking space is larger than the size of the second vehicle.

In some implementations, if the parking platform does not receive the size of the parking space from the first vehicle, the parking platform may compare the size of the first vehicle and the size of the second vehicle, and may determine that the parking space is large enough for the second vehicle when the size of the first vehicle is larger than the size of the second vehicle.

In some implementations, matching the second vehicle with the parking space may be based solely on the location of the parking space, and the size of the parking space may not be utilized unless the second vehicle is oversized. In some implementations, the parking platform may determine that the parking space is large enough for the second vehicle when the size of the parking space satisfies a threshold size associated with the second vehicle.

As shown in FIG. 1F, and by reference number 145, when the parking platform determines that the first vehicle is parked in the geographical area and that the parking space is large enough for the second vehicle, the parking platform may provide, to the first user device, a notification indicating that the second vehicle wants the parking space in a particular period of time and that the second user is willing to pay the particular price (e.g., $40). In some implementations, the first user device may receive the notification, and may provide the notification for display to the first user, via a user interface. For example, the user interface may indicate that the first user can be paid a price (e.g., $40.00) for the parking space if the first user moves the first vehicle from the parking space in fifteen (15) minutes. The user interface may also include a mechanism (e.g., an “Accept” button, icon, link, and/or the like) that, when selected, causes the first user device to provide, to the parking platform, a response to the notification.

In some implementations, the time period for moving the first vehicle may be based on an estimated time associated with the second vehicle arriving at the parking space. In such implementations, the parking platform may track the second vehicle, and may estimate when the second vehicle will arrive at the parking space. In some implementations, the parking platform may provide a message to the first vehicle when the second vehicle arrives at the parking space to ensure that the first vehicle does not leave the parking space too early and another vehicle takes the parking space. If the first vehicle leaves the parking space too early and another vehicle occupies the parking space before the second vehicle arrives, then the parking platform may prevent payment of the price from the first user to the second user. In other words, the second user may only pay the first user when the second vehicle parks in the parking space.

If the first user wishes to accept the offer of the price for the parking space, the user may select the “Accept” mechanism and the first user device may provide, to the parking platform, a response indicating that the first vehicle will give up the parking space for the second vehicle in the particular time period and for the particular price. As further shown in FIG. 1F, and by reference number 150, the parking platform may receive the response indicating that the first vehicle will give up the parking space for the second vehicle in the particular time period and for the particular price.

As shown in FIG. 1G, and by reference number 155, when the parking platform receives the response indicating that the first vehicle will give up the parking space for the second vehicle in the particular time period and for the particular price, the parking platform may provide, to the second user device, a notification indicating that the first vehicle will give up the parking space for the second vehicle in the particular time period and for the particular price. In some implementations, the second user device may receive the notification, and may provide the notification for display to the second user, via a user interface. For example, the user interface may indicate that the first vehicle will give up the parking space for the particular price (e.g., $40.00), and may provide directions to the parking space. In some implementations, the second user device may provide, to the GPS of the second vehicle, the directions to the parking space so that the second vehicle may provide turn-by-turn directions to the parking space. In some implementations, if the second vehicle is an autonomous vehicle, the second vehicle may utilize the directions to autonomously drive to the parking space. In some implementations, the second user device may utilize the directions to provide turn-by-turn directions to the parking space.

As shown in FIG. 1H, as the second vehicle approaches or is located at the parking space, the second user may provide, to the second user device and via a user interface, information indicating that the second vehicle is located at the parking space and requesting that the first vehicle be notified. The user interface may also include a mechanism (e.g., an “Enter” button, icon, link, and/or the like) that, when selected, causes the second user device to provide, to the parking platform, a notification indicating that the second vehicle is located at the parking space. In some implementations, the second user device may not require the second user to utilize the user interface and may automatically generate the notification based on the location of the second vehicle (e.g., a GPS location), the particular location of the parking space, the driving directions, and/or the like. As further shown in FIG. 1H, and by reference number 160, the parking platform may receive, from the second user device, the notification indicating that the second vehicle is located at the parking space.

As further shown in FIG. 1H, and by reference number 165, when the parking platform receives the notification indicating that the second vehicle is located at the parking space, the parking platform may provide, to the first user device, a notification indicating that the second vehicle is waiting for the parking space and identifying a make, a model, and a color of the second vehicle. In some implementations, the first user device may receive the notification, and may provide the notification for display to the first user, via a user interface. For example, the user interface may indicate that the second vehicle has arrived and is ready to park, and that the second vehicle is a green 1998 Model ZZ. In some implementations, the notification may include landmarks (e.g., a particular road, building, park, and/or the like) associated with the location of the parking space.

In some implementations, based on the notification, the first user may drive the first vehicle out of the parking space so that the second vehicle may occupy the parking space. In some implementations, if the first vehicle is an autonomous vehicle, the first user may instruct (e.g., via the first user device) the first vehicle to exit the parking space based on the notification. The autonomous first vehicle may exit the parking space and may autonomously drive around the geographical area, locate and park at another parking space, drive to pick up the first user, and/or the like. Once the first vehicle leaves the parking space, the second vehicle may enter and park in the parking space.

As shown in FIG. 1I, once the second vehicle parks in the parking space, the second user may provide, to the second user device and via a user interface, information indicating that the second vehicle has parked in the parking space and requesting that the first user be paid. The user interface may also include a mechanism (e.g., an “Accept” button, icon, link, and/or the like) that, when selected, causes the second user device to provide, to the parking platform, a notification indicating that the second vehicle has parked in the parking space and authorizing payment of the price to the first user. In some implementations, the second user device may not require the second user to utilize the user interface, and may automatically generate the notification based on the location of the second vehicle matching the particular location of the parking space. As further shown in FIG. 11I, and by reference number 170, the parking platform may receive, from the second user device, the notification indicating that the second vehicle has parked in the parking space and authorizing payment of the price to the first user.

In some implementations, based on the notification, the parking platform may cause a transaction of an amount (e.g., the price) to be transferred from an account, associated with the second user, to an account associated with first user. For example, the parking platform may transfer $40.00 from the account of the second user to the account of the first user. In some implementations, a portion of the amount (e.g., a service fee, a parking fee, and/or the like) may be provided to an account of a third party (e.g., an operator of the parking platform, an owner of the parking space, and/or the like), and a remaining portion of the amount may be provided to the first user.

As further shown in FIG. 11I, and by reference number 175, once the amount is transferred from the account of the second user to the account of the first user, the parking platform may provide, to the first user device, a notification indicating that the second user paid the amount to the account of the first user. In some implementations, the first user device may receive the notification, and may provide the notification for display to the first user, via a user interface. For example, the user interface may indicate that the account of the first user has been credited $40.00.

In some implementations, when the second vehicle is traveling to the parking space, the parking platform may receive, from the second user device, information indicating a current location of the second vehicle, and may receive current traffic condition information associated with the current location. In such implementations, the parking platform may determine an estimated time when the second vehicle will be located at the parking space based on the current location, the current traffic condition information, and the particular location of the parking space. The parking platform may provide, to the first user device, information indicating the estimated time when the second vehicle will be located at the parking space. In some implementations, the parking platform may provide, to the first user device, live tracking information associated with the second vehicle, a make, model, and color of the second vehicle, an image of the second user, and/or the like, to ensure that the first user identifies the second user and the second vehicle.

In some implementations, if the second vehicle locates another parking space before arriving at the parking space, the parking platform may receive, from the second user device and prior to causing the transaction, information indicating that the second vehicle found another parking space. In such implementations, the parking platform may prevent the transaction based on receiving the information indicating that the second vehicle found the other parking space, if the first vehicle has not exited the parking space, within a particular time period of receiving the response (e.g., agreeing to the transaction) from the first user device, and/or the like. Otherwise, the second user may still need to pay the amount (or a portion of the amount) even though the other parking space was found by the second vehicle.

In some implementations, the parking platform may provide the notification, indicating that the second vehicle will pay the price for the parking space, to the first user device only when the price satisfies a threshold price set by the first user device. In some implementations, the parking platform may receive the response, indicating that the first vehicle will give the parking space to the second vehicle, from the first user device only when the price satisfies the threshold price set by the first user device.

In some implementations, if the parking space is in a parking lot owned by a third party, the second user may need to pay money to the first user and to the third party. In some implementations, if the first vehicle needs to be moved from a parking space after a particular time period, the first user may configure the first user device to provide one or more notifications (e.g., alarms) indicating when the first vehicle needs to be moved from the parking space. In some implementations, the parking platform may implement rules to prevent abuse of the system (e.g., moving from one parking space to another parking space), such as a rule limiting an amount a user can charge in a time period (e.g., a day). In some implementations, the parking platform may permit owners of certain parking spaces (e.g., private parking lots, parking lots of merchants, and/or the like) to opt out of allowing users to utilize the parking platform in the certain parking spaces.

In this way, several different stages of the process for locating and bidding for a parking space are automated, which may remove human subjectivity and waste from the process, and which may improve speed and efficiency of the process and conserve computing resources (e.g., processing resources, memory resources, and/or the like). Furthermore, implementations described herein use a rigorous, computerized process to perform tasks or roles that were not previously performed or were previously performed using subjective human intuition or input. For example, currently there does not exist a technique to locate and bid for a parking space based on peer-to-peer communication of parking information. Finally, automating the process for locating and bidding for a parking space conserves computing resources (e.g., processing resources, memory resources, and/or the like) that would otherwise be wasted in attempting to locate and bid for a parking space.

As indicated above, FIGS. 1A-1I are provided merely as examples. Other examples are possible and may differ from what was described with regard to FIGS. 1A-1I.

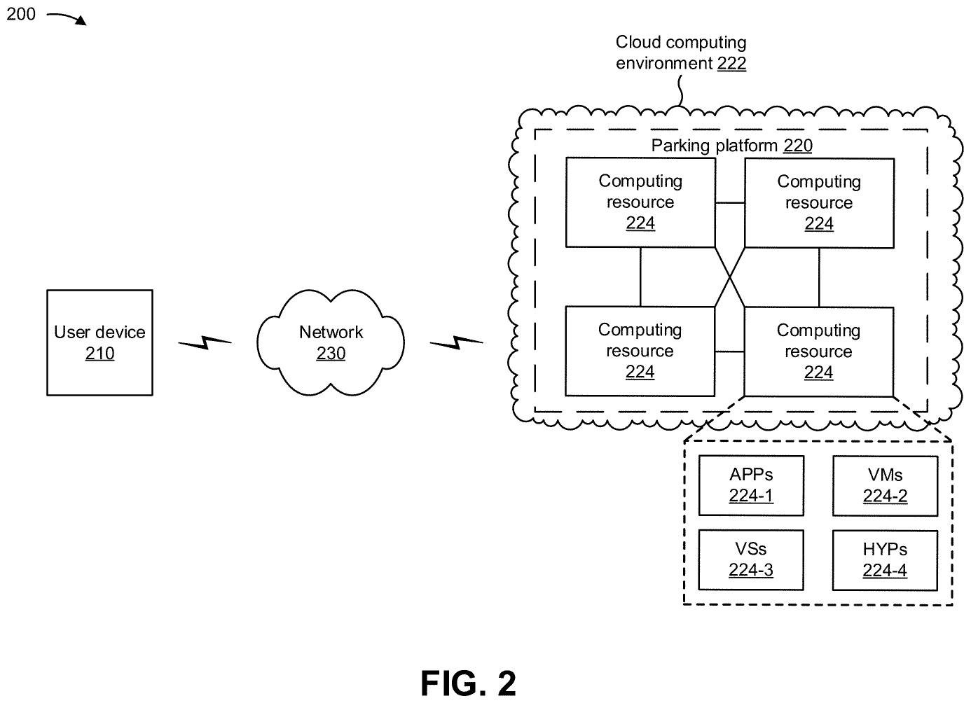

FIG. 2 is a diagram of an example environment 200 in which systems and/or methods, described herein, may be implemented. As shown in FIG. 2, environment 200 may include a user device 210, a parking platform 220, and a network 230. Devices of environment 200 may interconnect via wired connections, wireless connections, or a combination of wired and wireless connections.

User device 210 includes one or more devices capable of receiving, generating, storing, processing, and/or providing information, such as information described herein. For example, user device 210 may include a mobile phone (e.g., a smart phone, a radiotelephone, etc.), a laptop computer, a tablet computer, a desktop computer, a handheld computer, a gaming device, a wearable communication device (e.g., a smart wristwatch, a pair of smart eyeglasses, etc.), or a similar type of device. In some implementations, user device 210 may receive information from and/or transmit information to parking platform 220.

Parking platform 220 includes one or more devices that manage peer-to-peer communication of parking information among user devices 210. In some implementations, parking platform 220 may be designed to be modular such that certain software components may be swapped in or out depending on a particular need. As such, parking platform 220 may be easily and/or quickly reconfigured for different uses. In some implementations, parking platform 220 may receive information from and/or transmit information to one or more user devices 210.

In some implementations, as shown, parking platform 220 may be hosted in a cloud computing environment 222. Notably, while implementations described herein describe parking platform 220 as being hosted in cloud computing environment 222, in some implementations, parking platform 220 may not be cloud-based (i.e., may be implemented outside of a cloud computing environment) or may be partially cloud-based.

Cloud computing environment 222 includes an environment that hosts parking platform 220. Cloud computing environment 222 may provide computation, software, data access, storage, etc. services that do not require end-user knowledge of a physical location and configuration of system(s) and/or device(s) that hosts parking platform 220. As shown, cloud computing environment 222 may include a group of computing resources 224 (referred to collectively as “computing resources 224” and individually as “computing resource 224”).

Computing resource 224 includes one or more personal computers, workstation computers, server devices, or other types of computation and/or communication devices. In some implementations, computing resource 224 may host parking platform 220. The cloud resources may include compute instances executing in computing resource 224, storage devices provided in computing resource 224, data transfer devices provided by computing resource 224, etc. In some implementations, computing resource 224 may communicate with other computing resources 224 via wired connections, wireless connections, or a combination of wired and wireless connections.

As further shown in FIG. 2, computing resource 224 includes a group of cloud resources, such as one or more applications (“APPs”) 224-1, one or more virtual machines (“VMs”) 224-2, virtualized storage (“VSs”) 224-3, one or more hypervisors (“HYPs”) 224-4, and/or the like.

Application 224-1 includes one or more software applications that may be provided to or accessed by user device 210. Application 224-1 may eliminate a need to install and execute the software applications on user device 210. For example, application 224-1 may include software associated with parking platform 220 and/or any other software capable of being provided via cloud computing environment 222. In some implementations, one application 224-1 may send/receive information to/from one or more other applications 224-1, via virtual machine 224-2.

Virtual machine 224-2 includes a software implementation of a machine (e.g., a computer) that executes programs like a physical machine. Virtual machine 224-2 may be either a system virtual machine or a process virtual machine, depending upon use and degree of correspondence to any real machine by virtual machine 224-2. A system virtual machine may provide a complete system platform that supports execution of a complete operating system (“OS”). A process virtual machine may execute a single program, and may support a single process. In some implementations, virtual machine 224-2 may execute on behalf of a user (e.g., a user of user device 210 or an operator of parking platform 220), and may manage infrastructure of cloud computing environment 222, such as data management, synchronization, or long-duration data transfers.

Virtualized storage 224-3 includes one or more storage systems and/or one or more devices that use virtualization techniques within the storage systems or devices of computing resource 224. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 224-4 may provide hardware virtualization techniques that allow multiple operating systems (e.g., “guest operating systems”) to execute concurrently on a host computer, such as computing resource 224. Hypervisor 224-4 may present a virtual operating platform to the guest operating systems, and may manage the execution of the guest operating systems. Multiple instances of a variety of operating systems may share virtualized hardware resources.

Network 230 includes one or more wired and/or wireless networks. For example, network 230 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

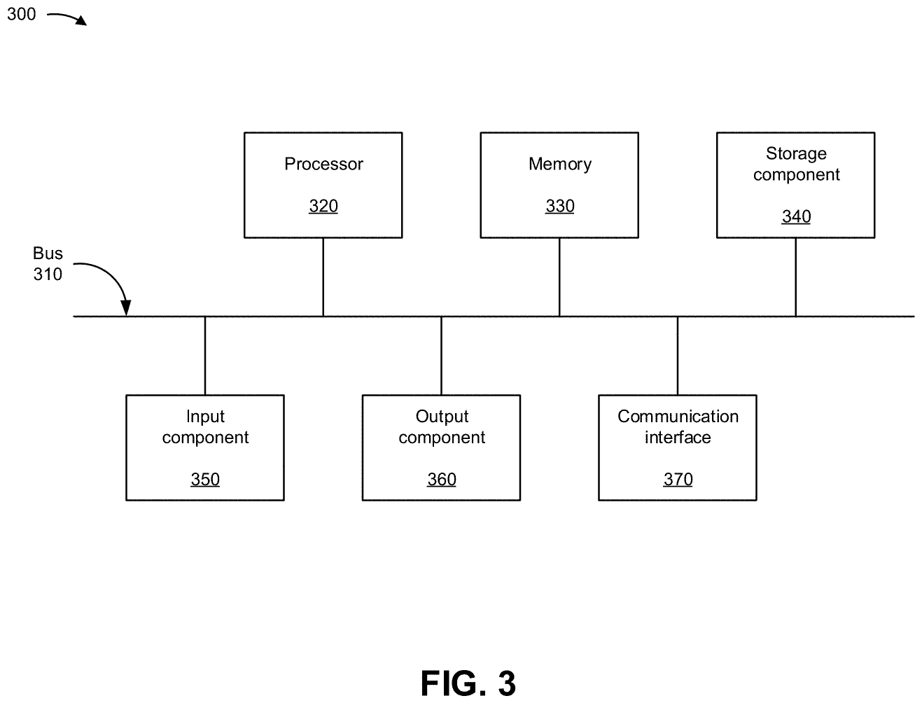

FIG. 3 is a diagram of example components of a device 300. Device 300 may correspond to user device 210, parking platform 220, and/or computing resource 224. In some implementations, user device 210, parking platform 220, and/or computing resource 224 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 includes a component that permits communication among the components of device 300. Processor 320 is implemented in hardware, firmware, or a combination of hardware and software. Processor 320 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, and/or the like.

Device 300 may perform one or more processes described herein. Device 300 may perform these processes based on processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

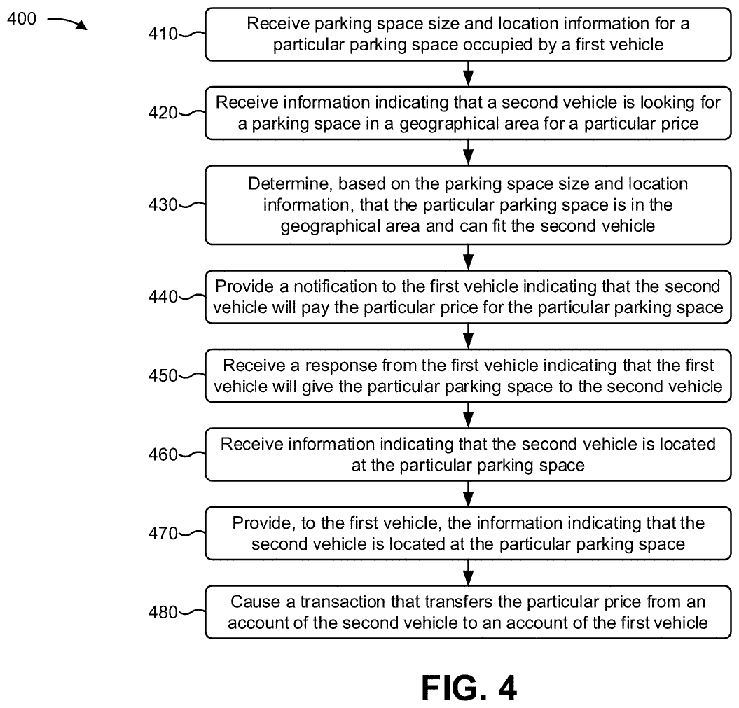

FIG. 4 is a flow chart of an example process 400 for locating and bidding for a parking space based on peer-to-peer communication of parking information. In some implementations, one or more process blocks of FIG. 4 may be performed by a parking platform (e.g., parking platform 220). In some implementations, one or more process blocks of FIG. 4 may be performed by another device or a group of devices separate from or including parking platform 220, such as user device 210.

As shown in FIG. 4, process 400 may include receiving parking space size and location information for a particular parking space occupied by a first vehicle (block 410). For example, the parking platform (e.g., using computing resource 224, processor 320, communication interface 370, and/or the like) may receive parking space size and location information for a particular parking space occupied by a first vehicle, as described above in connection with FIGS. 1A-2.

As further shown in FIG. 4, process 400 may include receiving information indicating that a second vehicle is looking for a parking space in a geographical area for a particular price (block 420). For example, the parking platform (e.g., using computing resource 224, processor 320, storage component 340, communication interface 370, and/or the like) may receive information indicating that a second vehicle is looking for a parking space in a geographical area for a particular price, as described above in connection with FIGS. 1A-2.

As further shown in FIG. 4, process 400 may include determining, based on the parking space size and location information, that the particular parking space is in the geographical area and can fit the second vehicle (block 430). For example, the parking platform (e.g., using computing resource 224, processor 320, memory 330, and/or the like) may determine, based on the parking space size and location information, that the particular parking space is in the geographical area and can fit the second vehicle, and the vehicle location information, as described above in connection with FIGS. 1A-2.

As further shown in FIG. 4, process 400 may include providing a notification to the first vehicle indicating that the second vehicle will pay the particular price for the particular parking space (block 440). For example, the parking platform (e.g., using computing resource 224, processor 320, memory 330, communication interface 370, and/or the like) may provide a notification to the first vehicle indicating that the second vehicle will pay the particular price for the particular parking space, as described above in connection with FIGS. 1A-2.

As further shown in FIG. 4, process 400 may include receiving a response from the first vehicle indicating that the first vehicle will give the particular parking space to the second vehicle (block 450). For example, the parking platform (e.g., using computing resource 224, processor 320, communication interface 370, and/or the like) may receive a response from the first vehicle indicating that the first vehicle will give the particular parking space to the second vehicle, as described above in connection with FIGS. 1A-2.

As further shown in FIG. 4, process 400 may include receiving information indicating that the second vehicle is located at the particular parking space (block 460). For example, the parking platform (e.g., using computing resource 224, processor 320, memory 330, communication interface 370, and/or the like) may receive information indicating that the second vehicle is located at the particular parking space, as described above in connection with FIGS. 1A-2.

As further shown in FIG. 4, process 400 may include providing, to the first vehicle, the information indicating that the second vehicle is located at the particular parking space (block 470). For example, the parking platform (e.g., using computing resource 224, processor 320, storage component 340, communication interface 370, and/or the like) may provide, to the first vehicle, the information indicating that the second vehicle is located at the particular parking space, as described above in connection with FIGS. 1A-2.

As further shown in FIG. 4, process 400 may include causing a transaction that transfers the particular price from an account of the second vehicle to an account of the first vehicle (block 480). For example, the parking platform (e.g., using computing resource 224, processor 320, memory 330, communication interface 370, and/or the like) may cause a transaction that transfers the particular price from an account of the second vehicle to an account of the first vehicle, as described above in connection with FIGS. 1A-2.

Process 400 may include additional implementations, such as any single implementation or any combination of implementations described below and/or described with regard to any other process described herein.

In some implementations, the parking platform may receive, from the second device, a second notification indicating that the second vehicle entered the particular parking space and that the second device authorizes paying the particular price, and may cause the transaction based on receiving the second notification. In some implementations, the parking platform may provide, to the first device, a third notification indicating that the amount of money, based on the particular price, has been credited to the account associated with the first device. In some implementations, the information indicating that the second vehicle is located at the particular parking space may include information identifying the second vehicle. In some implementations, the parking space size information may be based on a size of the first vehicle, or information received from a crash detection system of the first vehicle.

In some implementations, the parking platform may receive, from the second device, current location information indicating a current location of the second vehicle, may receive current traffic condition information associated with the current location information, may determine an estimated time when the second vehicle will be located at the particular parking space based on the current location information, the current traffic condition information, and the parking space location information, and may provide, to the first device, information indicating the estimated time when the second vehicle will be located at the particular parking space. In some implementations, the parking platform may receive, from the second device, current location information indicating a current location of the second vehicle, may determine that the current location information matches the parking space location information, may determine that the second vehicle entered the particular parking space based on determining that the current location information matches the parking space location information, and may cause the transaction based on determining that the second vehicle entered the particular parking space.

In some implementations, the parking platform may provide, to the second device and based on the response, information identifying the first vehicle and information identifying landmarks associated with the particular parking space. In some implementations, the parking platform may receive, from the second device and prior to causing the transaction, information indicating that the second vehicle found another parking space, and may prevent the transaction based on receiving the information indicating that the second vehicle found the other parking space. In some implementations, the parking platform may cause a first transaction that transfers a first amount of money from an account associated with the second device to an account associated with the first device, and may cause a second transaction that transfers a second amount of money from the account associated with the second device to an account associated with the third party, where the first amount of money and the second amount of money are based on the particular price.

In some implementations, the first vehicle may be an autonomous vehicle that automatically exits the particular parking space for the second vehicle. In some implementations, the first notification, indicating that the second vehicle will pay the particular price for the particular parking space, may be provided to the first device when the particular price satisfies a threshold price set by the first device, and the response, indicating that the first vehicle will give the particular parking space to the second vehicle, may be received from the first device when the particular price satisfies the threshold price set by the first device. In some implementations, the parking platform may receive, from the second device, current location information indicating the current location of the second vehicle, may receive current traffic condition information associated with the current location information, may determine an estimated time when the second vehicle will be located at the particular parking space based on the current location information, the current traffic condition information, and the parking space location information, and may provide, to the first device, information indicating the estimated time when the second vehicle will be located at the particular parking space.

In some implementations, the parking platform may cause a transaction that transfers an amount of money, based on the particular price, from an account associated with the second user device to an account associated with the first user device, after the first vehicle exits the particular parking space and the second vehicle enters the particular parking space. In some implementations, the parking platform may provide, to the first user device, a second notification indicating that the amount of money, based on the particular price, has been credited to the account associated with the first user device. In some implementations, the parking platform may provide, to the second user device and based on the response, information identifying a make, a model, and a year associated with the first vehicle. In some implementations, the parking platform may receive, from the second user device, current location information indicating a current location of the second vehicle, may determine that the current location information matches the parking space location information, and may determine that the second vehicle entered the particular parking space based on determining that the current location information matches the parking space location information.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

Some implementations described herein provide a parking platform that locates a parking space based on peer-to-peer to communication of parking information. For example, the parking platform may receive, from a first device associated with a first vehicle, parking space size information for a parking space occupied by the first vehicle, and parking space location information. The parking platform may receive, from a second device associated with a second vehicle, information indicating that the second vehicle is looking for a parking space in a geographical area for a price, and may determine that the parking space is in the geographical area. The parking platform may determine that the second vehicle fits in the parking space, and may receive, from the second device, information indicating that the second vehicle is located at the parking space. The parking platform may provide, to the first device, the information indicating that the second vehicle is located at the parking space, and may cause a transaction that transfers money, based on the price, from an account associated with the second device to an account associated with the first device.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Certain user interfaces have been described herein and/or shown in the figures. A user interface may include a graphical user interface, a non-graphical user interface, a text-based user interface, or the like. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

1. A device, comprising:
one or more memories; and
one or more processors configured to:
receive, from a first device associated with a first vehicle, parking space size information of a particular parking space,
the parking space size information indicating a plurality of distances between parking space boundaries and the first vehicle, and
the plurality of distances being determined via one or more sensors of the first vehicle;
receive, from a global positioning system (GPS) component of the first device or a GPS component of the first vehicle, parking space location information indicating a location of the particular parking space;
receive, from a second device associated with a second vehicle and via a user interface of an application installed on the second device, information indicating that a user associated with the second vehicle is looking for a parking space in a geographical area and a bid, for the parking space, representing a particular price that the user is willing to pay;
determine, based on the parking space location information, that the particular parking space is in the geographical area;
determine, based on the parking space size information, that the second vehicle physically fits in the particular parking space;
provide, to the first device and for display via a user interface of the first device, a first notification indicating the bid based on determining that the particular parking space is in the geographical area and that the second vehicle physically fits in the particular parking space;
receive, from the first device and based on a selection of a mechanism of the user interface of the first device, a response to the first notification indicating an acceptance of the bid;
provide, to the second device and based on the response, information indicating that the particular parking space is available to the second vehicle for the particular price;
receive, from the second device, information indicating that the second vehicle is located at the particular parking space based on providing the information indicating that the particular parking space is available to the second vehicle for the particular price;
provide, to the first device, the information indicating that the second vehicle is located at the particular parking space to prompt the first vehicle to exit the particular parking space and the second vehicle to enter the particular parking space; and
cause a transaction that transfers an amount of money, based on the particular price, from an account associated with the second device to an account associated with the first device after the first vehicle exits the particular parking space and the second vehicle enters the particular parking space.

2. The device of claim 1, wherein the one or more processors are further configured to:
receive, from the second device, a second notification indicating that the second vehicle entered the particular parking space and that the second device authorizes paying the particular price; and
wherein the one or more processors, when causing the transaction, are configured to:
cause the transaction based on receiving the second notification.

3. The device of claim 2, wherein the one or more processors are further configured to:
provide, to the first device, a third notification indicating that the amount of money, based on the particular price, has been credited to the account associated with the first device.

4. The device of claim 1, wherein the information indicating that the second vehicle is located at the particular parking space includes information identifying the second vehicle.

5. The device of claim 1, wherein the parking space size information is based on:
a size of the first vehicle, or
information received from a crash detection system of the first vehicle.

6. The device of claim 1, wherein the one or more processors are further configured to:
receive, from the second device, current location information indicating a current location of the second vehicle;
receive current traffic condition information associated with the current location information;
determine an estimated time when the second vehicle will be located at the particular parking space based on the current location information, the current traffic condition information, and the parking space location information; and
provide, to the first device, information indicating the estimated time when the second vehicle will be located at the particular parking space.

7. The device of claim 1, wherein the one or more processors are further configured to:
receive, from the second device, current location information indicating a current location of the second vehicle;
determine that the current location information matches the parking space location information; and
determine that the second vehicle entered the particular parking space based on determining that the current location information matches the parking space location information; and
wherein the one or more processors, when causing the transaction, are configured to:
cause the transaction based on determining that the second vehicle entered the particular parking space.

8. A non-transitory computer-readable medium storing instructions, the instructions comprising:
one or more instructions that, when executed by one or more processors of a device, cause the one or more processors to:
receive, from a first device associated with a first vehicle, parking space size information of a particular parking space,
the parking space size information indicating a plurality of distances between parking space boundaries and the first vehicle, and
the plurality of distances being determined via one or more sensors of the first vehicle;
receive, from a global positioning system (GPS) component of the first device or a GPS component of the first vehicle, parking space location information indicating a location of the particular parking space;
receive, from a second device associated with a second vehicle and via a user interface of an application installed on the second device, information indicating that a user associated with the second vehicle is looking for a parking space in a geographical area and a bid, for the parking space, representing a particular price that the user is willing to pay;
determine, based on the parking space location information, that the particular parking space is in the geographical area;
determine, based on the parking space size information, that the second vehicle physically fits in the particular parking space;
provide, to the first device and for display via a user interface of the first device, a first notification indicating the bid based on determining that the particular parking space is in the geographical area and that the second vehicle physically fits in the particular parking space;
receive, from the first device and based on a selection of a mechanism of the user interface of the first device, a response to the first notification indicating an acceptance of the bid;
calculate, based on the response, driving directions from a current location of the second vehicle to the location of the particular parking space;
provide, to the second device, the driving directions from the current location of the second vehicle to the location of the particular parking space;
determine, based on a location of the second vehicle, when the second vehicle is located at the particular parking space;
provide, to the first device, information indicating that the second vehicle is located at the particular parking space to prompt the first vehicle to exit the particular parking space and the second vehicle to enter the particular parking space; and
cause a transaction that transfers compensation, based on the particular price, from an account associated with the second device to an account associated with the first device after the first vehicle exits the particular parking space and the second vehicle enters the particular parking space.

9. The non-transitory computer-readable medium of claim 8, wherein the one or more instructions, when executed by the one or more processors, further cause the one or more processors to:
provide, to the second device and based on the response, information identifying the first vehicle and information identifying landmarks associated with the particular parking space.

10. The non-transitory computer-readable medium of claim 8, wherein the one or more instructions, when executed by the one or more processors, further cause the one or more processors to:
receive, from the second device and prior to causing the transaction, information indicating that the second vehicle found another parking space; and
prevent the transaction based on receiving the information indicating that the second vehicle found the other parking space.

11. The non-transitory computer-readable medium of claim 8, wherein the particular parking space is owned by a third party, and
wherein the one or more instructions, that cause the one or more processors to cause the transaction, cause the one or more processors to:
cause a first transaction that transfers a first amount of money from the account associated with the second device to the account associated with the first device; and
cause a second transaction that transfers a second amount of money from the account associated with the second device to an account associated with the third party,
wherein the first amount of money and the second amount of money are based on the particular price.

12. The non-transitory computer-readable medium of claim 8, wherein the first vehicle is an autonomous vehicle that automatically exits the particular parking space for the second vehicle.

13. The non-transitory computer-readable medium of claim 8, wherein the first notification indicating the bid is provided to the first device when the particular price satisfies a threshold price set by the first device, and
wherein the response to the first notification indicating the acceptance is received from the first device when the particular price satisfies the threshold price set by the first device.

14. The non-transitory computer-readable medium of claim 8, wherein the one or more instructions, when executed by the one or more processors, further cause the one or more processors to:
receive, from the second device, current location information indicating the current location of the second vehicle;
receive current traffic condition information associated with the current location information;
determine an estimated time when the second vehicle will be located at the particular parking space based on the current location information, the current traffic condition information, and the parking space location information; and
provide, to the first device, information indicating the estimated time when the second vehicle will be located at the particular parking space.

15. A method, comprising:
receiving, by a device and from a first user device associated with a first vehicle, parking space size information of a particular parking space,
the parking space size information indicating one or more distances between parking space boundaries and the first vehicle, and
the one or more distances being determined via one or more sensors or systems of the first vehicle;
receiving, by the device and from a global positioning system (GPS) component of the first user device or a GPS component of the first vehicle, parking space location information indicating a location of the particular parking space;
receiving, by the device and from a second user device associated with a second vehicle and via a user interface of an application installed on the second device, information indicating that a user associated with the second vehicle is seeking a parking space in a geographical area and a bid, for the parking space, representing a particular price that the user is willing to pay;
determining, by the device and based on the parking space location information, that the particular parking space is in the geographical area;
determining, by the device and based on the parking space size information, that the second vehicle physically fits in the particular parking space;
providing, by the device and for display via a user interface of the first user device, a first notification indicating the bid based on determining that the particular parking space is in the geographical area and that the second vehicle physically fits in the particular parking space;
receiving, by the device, from the first user device, and based on a selection of a mechanism of the user interface of the first device, a response to the first notification indicating an acceptance of the bid;
providing, by the device, to the second user device, and based on the response, information indicating that the particular parking space is available to the second vehicle for the particular price;
receiving, by the device and from the second user device, information indicating that the second vehicle is located at the particular parking space based on providing the information indicating that the particular parking space is available to the second vehicle for the particular price; and
providing, by the device and to the first user device, the information indicating that the second vehicle is located at the particular parking space to prompt the first vehicle to exit the particular parking space and the second vehicle to enter the particular parking space.

16. The method of claim 15, further comprising:
causing a transaction that transfers an amount of money, based on the particular price, from an account associated with the second user device to an account associated with the first user device after the first vehicle exits the particular parking space and the second vehicle enters the particular parking space.

17. The method of claim 16, further comprising:
providing, to the first user device, a second notification indicating that the amount of money, based on the particular price, has been credited to the account associated with the first user device.

18. The method of claim 15, further comprising:
receiving, from the second user device, current location information indicating a current location of the second vehicle;
receiving current traffic condition information associated the current location information;
determining an estimated time when the second vehicle will be located at the particular parking space based on the current location information, the current traffic condition information, and the parking space location information; and
providing, to the first user device, information indicating the estimated time when the second vehicle will be located at the particular parking space.

19. The method of claim 15, further comprising:
providing, to the second user device and based on the response to the first notification, information identifying a make, a model, and a year associated with the first vehicle.

20. The method of claim 15, further comprising:
receiving, from the second user device, current location information indicating a current location of the second vehicle;
determining that the current location information matches the parking space location information; and
determining that the second vehicle entered the particular parking space based on determining that the current location information matches the parking space location information.
